(19) United States
(12) Patent Application Publication
(10) Pub. No.: US 2012/0086290 A1
(43) Pub. Date: Apr. 12, 2012

(54) VARIABLE AMPLITUDE VIBRATORY APPLIANCE

(75) Inventors: Bengt IVARSSON, Hong Kong (CN); Bettina LEINWEBER, Hong Kong (CN); Hei Wai CHOI, Hong Kong (CN); David DYCHER, Shenzhen (CN); Greg SPOONER, Hong Kong (CN); Hoss VONG, Hong Kong (CN); James MACKINTOSH, Hong Kong (CN); Yee Wah LAM, Hong Kong (CN); Teruo HISHIKI, Hong Kong (CN)

(73) Assignee: HAYCO MANUFACTURING LIMITED, Hong Kong (CN)

(21) Appl. No.: 13/269,963

(22) Filed: Oct. 10, 2011

(30) Foreign Application Priority Data
Oct. 11, 2010 (HK) HK10109600.1

(51) Int. Cl. H02K 7/14

(52) U.S. Cl. 310/50

(57) ABSTRACT

A vibratory appliance includes a tool driven to oscillate by a rotary electric motor. A mechanism for converting rotary movement to oscillatory movement includes magnetic couplers moveable relative to one another. A displacement mechanism moves one of the magnetic couplers relative to the other magnetic coupler and varies the amplitude of oscillation of the tool.

### TECHNICAL FIELD

The present invention relates to hand-held motorised vibratory appliances in which the amplitude of movement of an oscillatory tool is adjustable.

### BACKGROUND OF THE INVENTION

An increasingly large range of types of hand-held electrical appliances are in use. These small appliances may include, for instance, personal care devices used for cleaning, grooming, physical stimulation, skin, hair or oral care, such as brushes, trimmers, razors, and the like, as well as other types of appliances for home or commercial use. In the use of personal care appliances a tool, such as a brush, a massage tool, applicator pad, blade, or the like, is motor-driven to oscillate. While users may readily select an appliance among different models according to a preference for the frequency of tool oscillation, the provision for a variable amplitude of oscillation to suit is less common. Advantageously, it is possible to provide a mild or intense action according to the amplitude of tool movement. Varying the amplitude of tool movement can be achieved in appliances having electromagnetic drives through the use of circuits that control the driving magnetic fields. However these types of control systems are relatively costly, and a need exists for a more inexpensive vibratory appliance which enables the amount of tool movement to be varied according to user preference.

As well as providing varying amounts of tool movement, it is known to employ a vibration exciter in an electric vibratory appliance to drive oscillation of the tool in different modes. For instance the oscillation may be rectilinear, rotational, orbital or a combination of these movements in different axes. Accordingly, a solution which enables the amount of tool movement to be varied should be able to accommodate different modes of tool movement, as well as providing a product which can be manufactured at relatively low cost. It is an object of the present invention to address the above needs, or more generally to provide an improved vibratory appliance.

### DISCLOSURE OF THE INVENTION

According to one aspect of the present invention there is provided a vibratory appliance comprising:

a tool mounted for movement relative to a housing;

an electric motor in the housing;

a driven member rotated about a drive axis by the electric motor;

a transmission for transmitting oscillatory movement to the tool;

a magnetic drive mechanism for converting rotation of the driven member to oscillation of the transmission, the magnetic drive mechanism including driving and driven magnet units each fixed to a respective one of the driven member and the transmission, a gap between the driving and driven magnet units, whereby, rotation of the drive magnet unit causes the drive magnet unit to act upon the driven magnet unit in order to cause oscillation of the transmission, and

displacement means for moving one of the driving and driven magnet units relative to the other to thereby vary the amount of oscillation of the tool.

Preferably the tool is a tool, most preferably a tooth tool. Optionally the tool may be a massage tool, an applicator pad, a trimmer or another personal care tool. Preferably the tool is resiliently mounted for movement relative to the housing.

Preferably the transmission comprises a shaft mounted in the housing to reciprocate longitudinally, the shaft having an intermediate portion between opposing inner and outer ends with journal means engaging the intermediate portion, the inner end of the shaft connected to the driven magnet unit and the outer end of the shaft connected to the tool such that linear reciprocation of the shaft oscillates the tool.

Preferably the driving magnet unit has a magnetic axis separating the poles, the axis being aligned substantially transverse to the drive axis.

Preferably the motor has an axis of rotation parallel to the longitudinal axis, the driven member comprises an output shaft of the motor, the driving magnet unit is fixed to rotate with the output shaft, the driven magnet unit is fixed to the inner end of the shaft, and the displacement means displaces the motor and driving magnet unit together substantially parallel to the first axis. Alternatively the driven member may be indirectly coupled to the motor shaft, as by one or more speed-change gear sets.

Preferably the housing has a longitudinal axis, and a resilient neck mounting the tool to the housing.

Preferably the housing further comprises guides aligned with the longitudinal axis and engaged with the motor for guiding longitudinal movement of the motor. Detents may be provided for holding one of the first and second couplers in the first and second relative positions.

Preferably the housing further comprises guides aligned with the longitudinal axis and engaged with the motor for guiding longitudinal movement of the motor.

Preferably the displacement means is user-controlled, as by operating one or more buttons, switches, grips, knobs or the like for moving the one of the first and second couplers relative to the other, either directly, by an intervening mechanism for example. Alternatively, the displacement means may be driven by an actuator controlled automatically in response, for instance, to a control, or to a current or voltage feedback.

User-operated displacement means may comprise a rotary operator having a knob by which it may be grasped by the user. For instance, the rotary operator may be mounted to turn in a transverse opening in the housing, a nub on the rotary operator offset from the transverse opening may be received in a substantially transverse channel, such that turning the rotary operator displaces the one of the first and second couplers relative to the other. Alternatively, the rotary operator may be connected to the housing by a screw thread having an axis parallel to the longitudinal axis, such that turning the rotary operator displaces the one of the first and second couplers relative to the other.

According to another aspect of the present invention there is provided a vibratory appliance comprising:

a housing having a handle portion;

a tool mounted for movement relative to the housing;

an electric motor in the housing;

a driven member rotated about a drive axis by the electric motor;

a transmission for transmitting oscillatory movement to the tool;

a driving magnet unit fixed to a the driven member;

a rocker pivotally mounted in the housing and operatively connected to the transmission;

at least one driven magnet unit mounted eccentrically to the rocker, and

a gap between the driving and driven magnet units, whereby, rotation of the drive magnet unit causes the drive magnet unit to act upon the driven magnet unit in order to cause oscillation of the rocker and the transmission, and

displacement means for moving one of the driving and driven magnet units relative to the other to thereby vary the amount of oscillation of the tool.

If one of the driving and driven magnet units comprises an electro-magnet, or permanent magnet, the other of the driving and driven magnet units may comprise an electro-magnet, a permanent magnet or a ferromagnetic material. If both driving and driven magnet units are permanent magnets or electromagnets the other of the driven magnet unit is alternately attracted and repelled. However, if one of the driving and driven magnet units is a permanent magnet or electromagnet, and the other of the driven magnet unit is a ferromagnetic material then the driven magnet unit may be periodically alternately attracted or repelled, against the action of a resilient member.

Preferably the transmission comprises a longitudinally extending shaft having an intermediate portion between opposing inner and outer ends, journal means engaging the intermediate portion to support the shaft for rotation, the inner end of the shaft connected to rocker to define a driven axis about which the rocker oscillates, and the outer end of the shaft connected to the tool such that turning the shaft twists the tool.

Preferably the motor has an axis of rotation defining a drive axis offset from or inclined to the driven axis, the driven member comprises an output shaft of the motor and the driving magnet unit is fixed to rotate with the output shaft.

Preferably the motor has an axis of rotation parallel to the longitudinal axis, the driven member comprises an output shaft of the motor, the driving magnet unit is fixed to rotate with the output shaft, the driven magnet unit is fixed to the inner end of the shaft, and the displacement means displaces the motor and driving magnet unit together substantially parallel to the first axis. Alternatively the driven member may be indirectly coupled to the motor shaft, as by one or more speed-change gear sets.

Preferably the displacement means for moving one of the driving and driven magnet units relative to the other may be like the displacement means for moving the one of the first and second couplers relative to the other, as discussed above.

The transmission may comprise a shaft mounted in the housing to reciprocate longitudinally, the shaft having an intermediate portion between opposing inner and outer ends with resilient means engaging the intermediate portion for urging the shaft to a first position, the inner end of the shaft connected to the driven magnet unit and the outer end of the shaft connected to the tool such that linear reciprocation of the shaft oscillates the tool.

Alternatively the transmission may comprise a shaft mounted in the housing to pivot transverse to its longitudinal axis, the shaft having an intermediate portion between opposing inner and outer ends, with resilient means engaging the intermediate portion for urging the shaft to a first position, the inner end of the shaft connected to the driven magnet unit and the outer end of the shaft connected to the tool such that pivoting reciprocation of the shaft oscillates the tool.

The transmission may further comprise a rocker to which the driven magnet unit is mounted, the inner end of the shaft being connected to the rocker such that the pivoting reciprocation of the inner end of the shaft follows an arcuate path.

It will be understood that the above-mentioned aspects of the vibratory appliance of the present invention are encompassed by a vibratory appliance comprising:

a housing having a handle portion;

a tool mounted for movement relative to the housing;

an electric motor in the housing;

a driven member rotated about a drive axis by the electric motor;

a transmission for transmitting oscillatory movement to the tool;

a mechanism for converting rotation of the driven member to oscillation of the transmission, the mechanism including first and second couplers each connected to a respective one of the driven member and the transmission means, and

displacement means for moving one of the first and second couplers relative to the other to thereby vary the amount of oscillation of the tool.

This invention provides a vibratory appliance which is effective and efficient in operational use, which has provision for varying the amount of brushing movement completed in each cycle of oscillation according to user requirements or preferences. New users can start use with a low setting, with a relatively low amount of movement, allowing them to be gently introduced to vibratory appliance use with a minimum of discomfort. Moreover, the vibratory appliance has an overall simple design which minimizes manufacturing costs and maximizes performance.

### BRIEF DESCRIPTION OF THE DRAWINGS

Preferred forms of the present invention will now be described by way of example with reference to the accompanying drawings, wherein:

FIG. 1 is a schematic longitudinal section through a vibratory appliance according to a first embodiment of the invention;

FIG. 2 is an exploded pictorial view of the vibratory appliance of FIG. 1 showing the brush in longitudinal section;

FIG. 3 is a fragmentary longitudinal section through the drive mechanism of FIG. 1;

FIG. 4 is an end view of the magnet units of the vibratory appliance of FIG. 1;

FIG. 5 is a schematic exploded isometric view of a vibratory appliance according to a second embodiment of the invention, an which some internal components are shown in longitudinal section, and

FIG. 6 is a schematic end view of the rocker of the vibratory appliance of FIG. 5.

### DESCRIPTION OF THE PREFERRED EMBODIMENTS

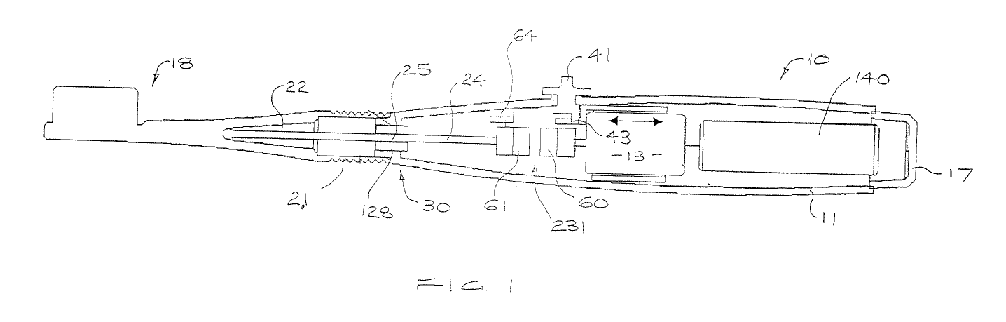

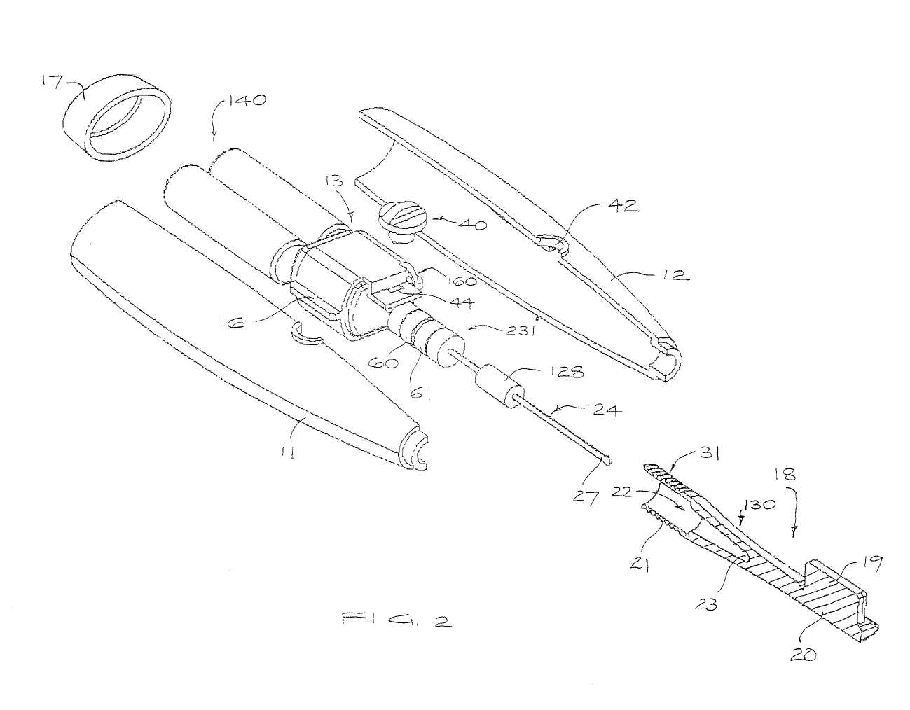

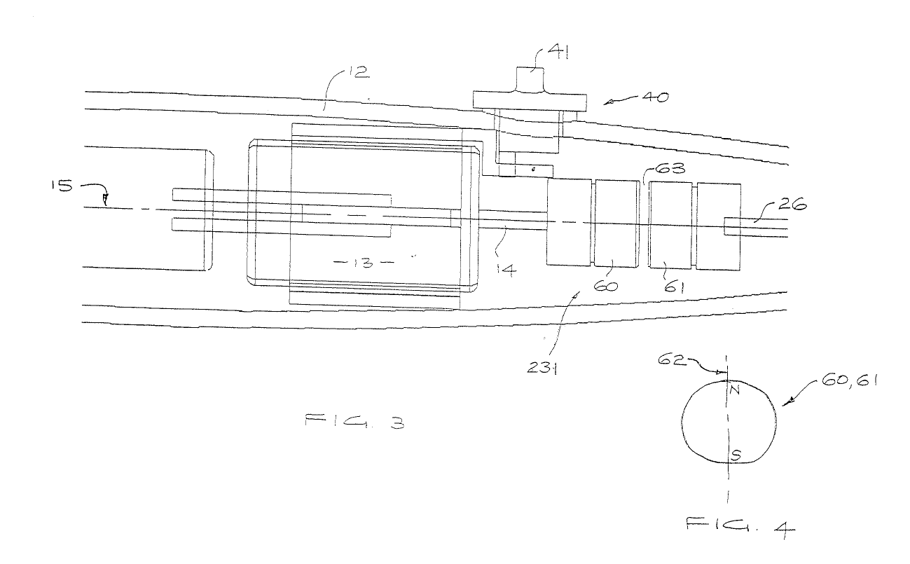

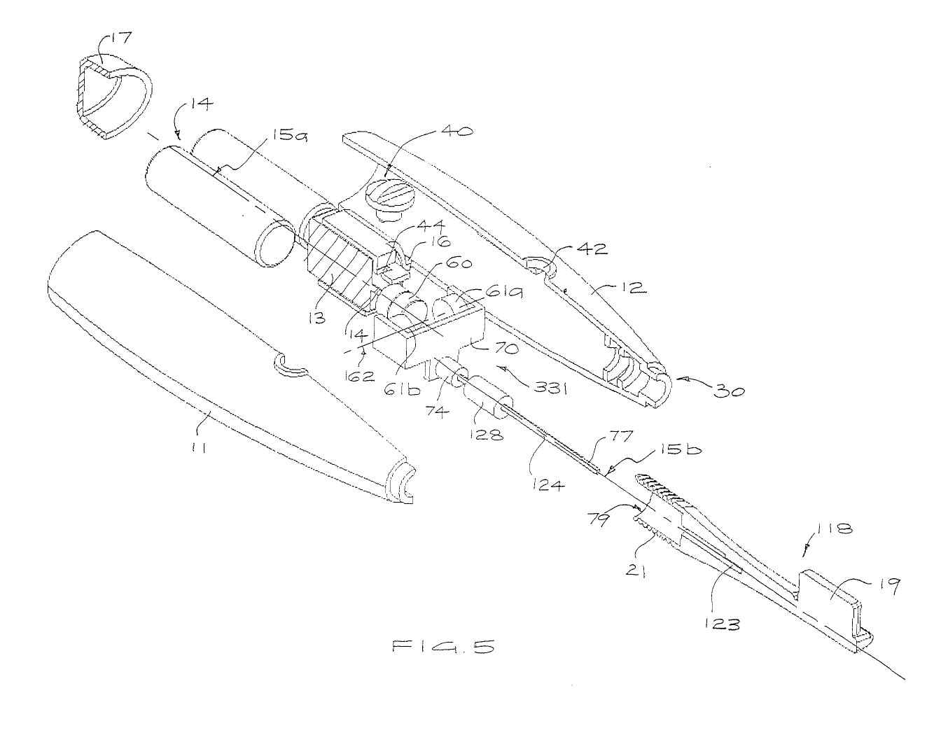

Referring to FIGS. 1-4, a first embodiment of a vibratory appliance according to the invention may comprise a housing 10, which may comprise a pair of elongate shells 11, 12 joined generally at a longitudinal plane. The housing 10 provides a handle portion by which the apparatus is held and encloses a rotary motor 13, and may also hold batteries 140 for powering the motor. The motor 13 has a rotating output shaft 14 aligned with a longitudinal axis 15. Guides are provided for allowing the motor to move longitudinally within the housing 10, and may comprise tongues 16 on opposing sides of a mount 160 to which the motor 13 is fixed. Each tongue 16 is slidingly received in a complementary groove (not shown) in the inner side of the shells 11 and 12. The tolerances are such that there is very little transverse play in this tongue and groove coupling. A cap 17 and a tool, such as a brush 18 are mounted to the longitudinally opposing ends of the housing 10.

The brush 18 may be a replaceable member having bristles 19 fixed in a bristle block 20 at its outer end. An elongate stem 130 connects the bristle block 20 to a resilient portion 21 disposed at the inner end of the brush 18. The resilient portion 21 may be integral with the bristle block 20 and stem 130 as shown. The resilient portion 21 may be formed with a plurality of circumferential ribs, such as ribs 31 axially adjacent one another. The brush 18 is thus flexibly mounted by the resilient portion 21, thereby allowing the bristle block 20 to move relative to the housing 10. A longitudinal cavity 22 in the brush 18 extends through the resilient portion 21 and has an open mouth at the inner end of the brush and a blind end 23 of a partly spherical form.

A shaft 24 is elongated longitudinally and has an intermediate portion 25 between opposing inner and outer ends 26 and 27 respectively. A bush 128 held in a neck 30 of the housing 10 extends about the intermediate portion 25 and provides a journal which supports the shaft 24 for generally longitudinal sliding movement. The outer end 27 of the shaft extends into the cavity 22 and may have a ball formed thereon, complementary in form to the blind end 23 in which it is engaged. The inner end 26 is connected to a magnetic drive mechanism 231, such that the shaft 24 and bush 128 provide a transmission for transmitting oscillatory movement to the brush 18.

The magnetic drive mechanism 231 comprises a magnetic coupling between driving and driven couplers, or magnet units 60 and 61 in a magnetic circuit. By the use of displacement means to move one of the coupling magnet units relative to the other the amount of oscillation of the brush during rotation of the motor may be varied.

The magnet units 60, 61 may be of like construction, each comprising a permanent magnet having a magnetic axis 62 separating their opposing magnetic poles N, S, the axis 62 being aligned substantially transverse to the axis 15. The magnet units may have a cylindrical form, with their axes parallel to the axis 15. In this manner rotation of the drive magnet unit 60 mounted to the motor shaft 14 causes the drive magnet unit 60 to alternately attract and repel the driven magnet unit 61. The driven magnet unit 61 is resiliently mounted to the housing 10, by virtue of the connection between the shaft 24 and the brush 18. A gap 63 is provided between the driving and driven magnet units 60, 61. Accordingly, as the driven magnet unit 61 is attracted and repelled it is displaced longitudinally relative to the drive magnet unit 60. The ball on the shaft end 27 may be received in the blind end 23 in a manner such that shaft 24 is able to both longitudinally extend and compress the resilient portion 21 during oscillation of the brush. Cooperating guide means 64 on the housing 10 and driven magnet unit 61 may be provided to restrain the movement of the driven magnet unit 61 to linear movement in the longitudinal direction.

Displacement means are provided, and may move the motor 13 and attached magnet unit 60 to thereby vary the amount of oscillation of the brush 18. Exemplary displacement means shown in FIGS. 1-3 comprise a rotary operator 40 having a knob 41 by which it may be grasped by the user. The rotary operator 40 is mounted to turn in a transverse opening 42 in the housing 10. An eccentric nub 43 on the rotary operator 40 is offset from the axis of the transverse opening 42. The nub 43 is received in a substantially transverse channel 44 in the motor mount 160 to which the motor 13 is fixed, such that turning the rotary operator 40 displaces the motor 13, and attached magnet unit 60 longitudinally. In use, the operator may rotate the rotary operator 40 to select a desired amount of brush movement. The rotary operator 40 is grasped by the user and turned to displace the motor 13, motor shaft 14 and driving magnet 60 longitudinally for varying the amount of displacement of the bristles 19 in the longitudinal direction. Friction, or other detent means, may hold the rotary operator 40 in any user-selected angular position.

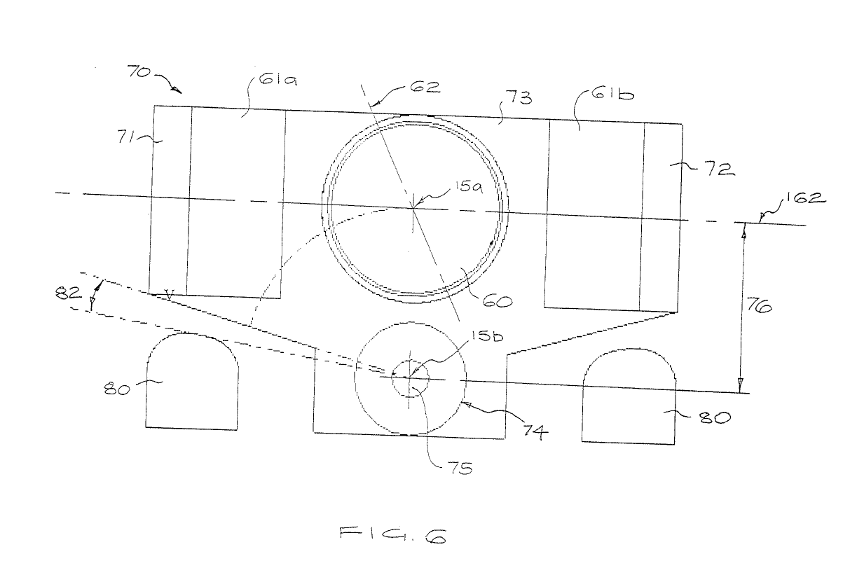

Referring to FIG. 5, a second embodiment of a toothbrush according to the invention incorporates a magnetic drive mechanism 331 which, like the magnetic drive mechanism 231, includes a driving magnet unit 60 mounted to rotate with the motor output shaft 14 (shown in longitudinal section) about the driving axis 15a.

Mounted on a rocker 70 are driven magnet units 61a, 61b disposed on opposing transverse sides of the driving axis 15a, with a gap therebetween into which the driving magnet unit 60 may extend. Like poles of the respective magnet units 61a, 61b are disposed adjacent the driving magnet unit 60. The magnetic axes 162 of the driven magnet units 61a, 61b may be parallel and/or coaxial (i.e. aligned with the geometric axis of their cylindrical forms) to one another. The coaxial magnetic axes 162 may be aligned substantially transverse to the driving axis 15a. The rocker 70 comprises a pair of opposing flanges 71, 72 joined by a web 73 to form a channel shape, with the driven magnet units 61a, 61b mounted inside the flanges 71, 72. A boss 74 may be provided integral with the web 73. An aperture 75 in the boss 74 defines a driven axis 15b generally parallel to the driving axis 15a, from which it is offset by dimension 76. The driven magnet units 61a, 61b are mounted eccentrically relative to the driving axis 15a of the rocker 70, such that torque is applied to the rocker by interaction between the magnet units.

The brush 118 has like construction as the first brush 18, except that a formation 123 is provided in the blind end. Complementary features (not shown) are provided on the inner end 79 of the brush and the neck 30 to prevent relative rotation between the neck 30 and the inner end 79 when the brush is mounted to the housing. The resilient portion 21 may be torsionally resilient, allowing the bristles 19 to rock about driven axis 15b between angular positions disposed either side of a central, neutral position, while there is no oscillation of the inner end 79.

On the outer end of the shaft 124 a formation 77 is provided, comprising one or more flats disposed about the periphery of the shaft, complementary to the formation 123 in the blind. The connection between these complementary formations allows torque to be transmitted between the shaft 124 and the brush 18, while providing a demountable connection for mounting the brush 118. The opposing inner end of the shaft 124 is fixed in the recess 75 in the rocker 70. The shaft 124 is journalled for rotation about the axis 15b in the bush 128, which is held in the neck portion of the housing 10. The shaft 124 may be a solid bar or, for greater torsional stiffness, a hollow bar. The shaft 124 is thus rotationally fast with the rocker 70, and serves to support the rocker 70 for oscillation within the housing 10 between two angular positions, while it is biased to the central position shown by the action of the resilient portion 21.

As shown in FIG. 6, a resilient bumper 80 may be provided on either side of the rocker 70 to abut the rocker and thus limit its angular movement, as to angle 82 either side of the neutral position shown.

In this manner, the motor 13 rotates the driving magnet unit 60, impelling the rocker 70 to oscillate about the longitudinal driven axis 15b, periodically reversing the torsion applied to the shaft 124 and to the brush 118. The bristles 19 are thus turned from side to side as the brush 18 is driven to twist. The rotary operator 40 may be grasped by the user and turned in the manner described above, to displace the motor 13 and driving magnet unit 60 longitudinally. As the driving magnet unit 60 is brought closer to the driven magnet units 61a, 61b larger impulses are transmitted through the shaft 124 to the brush, for varying the amount of displacement of the bristles 19 in operation.

Aspects of the present invention have been described by way of example only and it should be appreciated that modifications and additions may be made thereto without departing from the scope thereof.

1. A vibratory appliance comprising:
a housing having a handle portion;
a tool mounted for movement relative to the housing;
an electric motor in the housing;
a driven member rotated about a drive axis by the electric motor;
a transmission for transmitting oscillatory movement to the tool;
a magnetic drive mechanism for converting rotation of the driven member to produce the oscillatory movement of the transmission, the magnetic drive mechanism including driving and driven magnet units, each of the driving and driven magnet units being fixed to a respective one of the driven member and the transmission;
a gap between the driving and driven magnet units, whereby rotation of the drive magnet unit causes the drive magnet unit to act upon the driven magnet unit to produce the oscillatory movement for the transmission; and
displacement means for moving one of the driving and driven magnet units relative to the other of the driving and driven magnet units to vary amplitude of oscillation of the tool.

2. The vibratory appliance of claim 1 wherein the transmission comprises
a shaft having opposed inner and outer ends and an intermediate portion between the opposing inner and outer ends, and
journal means engaging the intermediate portion such that the shaft may reciprocate longitudinally, and
the inner end of the shaft is connected to the driven magnet unit and
the outer end of the shaft is connected to the tool such that linear reciprocation of the shaft oscillates the tool.

3. The vibratory appliance of claim 1 wherein
the driving magnet unit has poles and a magnetic axis separating the poles, and
the axis is substantially transverse to the drive axis.

4. The vibratory appliance of claim 2 wherein
the motor has an output shaft and an axis of rotation,
the driven member comprises the output shaft of the motor,
the driving magnet unit is fixed to rotate with the output shaft of the motor,
the driven magnet unit is fixed to the inner end of the shaft, and
the displacement means displaces the motor and the driving magnet unit together, substantially parallel to the axis of rotation, to vary amplitude of oscillation of the tool.

5. The vibratory appliance of claim 1 including a resilient member, wherein the tool is mounted to the housing by the resilient member.

6. The vibratory appliance of claim 1 wherein the housing further comprises a longitudinal axis and guides aligned with the longitudinal axis and engaged with the motor for guiding longitudinal movement of the motor.

7. The vibratory appliance of claim 1 wherein the displacement means comprises a rotary operator having a knob for grasping by a user of the appliance.

8. The vibratory appliance of claim 7 wherein
the housing has a transverse opening.
the rotary operator has a nub,
the rotary operator is mounted to turn in the transverse opening in the housing, and
the nub on the rotary operator is offset from the transverse opening and is received in a substantially transverse channel, such that turning the rotary operator displaces one of first and second couplers relative to the other of the first and second couplers.

9. The vibratory appliance of claim 1 wherein the magnetic drive mechanism further comprises a pivotally mounted rocker in the housing that is operatively connected to the transmission.

10. A vibratory appliance comprising:
a housing having a handle portion;
a tool mounted for movement relative to the housing;
an electric motor in the housing;
a driven member rotated about a drive axis by the electric motor;
a transmission for transmitting oscillatory movement to the tool;
a driving magnet unit fixed to the driven member;
a rocker pivotally mounted in the housing and operatively connected to the transmission;
at least one driven magnet unit mounted eccentrically to the rocker,
a gap between the driving and driven magnet units, whereby, rotation of the drive magnet unit causes the drive magnet unit to act upon the driven magnet unit in order to cause oscillatory movement of the rocker and of the transmission; and
displacement means for moving one of the driving and driven magnet units relative to the other of the driving and driven magnet units to vary amplitude of oscillation of the tool.

11. The vibratory appliance of claim 10 wherein the transmission comprises
a longitudinally extending shaft having opposing inner and outer ends and an intermediate portion between the opposing inner and outer ends, and
journal means engaging the intermediate portion to support the shaft for rotation,
the inner end of the shaft is connected to the rocker to define a driven axis about which the rocker oscillates, and
the outer end of the shaft is connected to the tool such that turning the shaft twists the tool.

12. The vibratory appliance of claim 11 wherein the motor has an output shaft and an axis of rotation defining the drive axis, which is offset from or inclined to the driven axis,
the driven member comprises the output shaft of the motor, and
the driving magnet unit is fixed to rotate with the output shaft of the motor.

13. The vibratory appliance of claim 11 wherein
the driving magnet unit has poles and a magnetic axis separating the poles, and
the axis is substantially transverse to the drive axis.

14. The vibratory appliance of claim 13 including a resilient member, wherein the tool is mounted to the housing by the resilient member.

15. The vibratory appliance of claim 10 wherein the housing further comprises a longitudinal axis and guides aligned with the longitudinal axis and engaged with the motor for guiding longitudinal movement of the motor.

16. The vibratory appliance of claim 10 wherein the displacement means comprises a rotary operator having a knob for grasping by a user of the appliance.

17. The vibratory appliance of claim 16 wherein
the housing has a transverse opening.
the rotary operator has a nub,
the rotary operator is mounted to turn in the transverse opening in the housing, and
the nub on the rotary operator is offset from the transverse opening and is received in a substantially transverse channel, such that turning the rotary operator displaces one of first and second couplers relative to the other of the first and second couplers.

18. A vibratory appliance comprising:
a housing having a handle portion;
a tool mounted for movement relative to the housing;
an electric motor in the housing;
a driven member rotated about a drive axis by the electric motor;
a transmission assembly for transmitting oscillatory movement to the tool;
a mechanism for converting rotation of the driven member to the oscillatory movement for the transmission, the mechanism including first and second magnetic couplers, each of the first and second magnetic couplers being fixed to a respective one of the driven member and the transmission assembly; and
displacement means for moving one of the first and second couplers relative to the other of the first and second magnetic couplers to vary amplitude of oscillation of the tool.

19. The vibratory appliance of claim 18 wherein the transmission assembly comprises
a shaft having opposing inner and outer ends and an intermediate portion between the opposing inner and outer ends, and
journal means engaging the intermediate portion to support the shaft for rotation,
the inner end of the shaft is fixed to the second magnetic coupler,
the outer end of the shaft protrudes from the housing for receipt in a complementary opening in the tool,
the motor has an output shaft,
the driven member comprises the output shaft of the motor,
the first magnetic coupler is fixed to the output shaft of the motor, has poles, and has a magnetic axis separating the poles, the magnetic axis being substantially transverse to an axis of the output shaft of the motor, and
the displacement means comprises a rotary operator which may be turned to move one of the first and second magnetic couplers relative to the other of the first and second magnetic couplers.

20. The vibratory appliance of claim 19 including a resilient member, wherein
the tool is mounted to the housing through the resilient member, and
the displacement means displaces the motor and the first magnetic coupler together, substantially parallel to the axis of rotation, to vary the amplitude of oscillation of the tool.
